(19) United States
(12) Patent Application Publication
(10) Pub. No.: US 2026/0062314 A1
(43) Pub. Date: Mar. 5, 2026

(54) METAL COMPOSITE COMPOUND AND CATHODE ACTIVE MATERIAL WITH METAL COMPOSITE COMPOUND AS PRECURSOR

(71) Applicant: TANAKA CHEMICAL CORPORATION, Fukui (JP)

(72) Inventors: Jinto MATSUTA, Fukui (JP); Ayaka NAKAYA, Fukui (JP)

(73) Assignee: TANAKA CHEMICAL CORPORATION, Fukui (JP)

(21) Appl. No.: 19/311,884

(22) Filed: Aug. 27, 2025

(30) Foreign Application Priority Data
Aug. 28, 2024 (JP) 2024-146278

(51) Int. Cl. C01G 53/05; H01M 10/0525

(52) U.S. Cl. CPC C01G 53/05; H01M 10/0525; C01P 2002/72; C01P 2004/51; C01P 2006/11; C01P 2006/40

(57) ABSTRACT

Provided is a metal composite compound, wherein a relative standard deviation of a volume-based crystallite size distribution, calculated from a diffraction peak within the range 2θ=38±1° in a powder X-ray diffraction measurement using CuKα radiation, is less than 0.70.

### CROSS REFERENCE TO RELATED APPLICATIONS

The present application claims the benefit of foreign priority to Japanese Patent Application No. 2024-146278, filed on Aug. 28, 2024, which is incorporated herein by reference in its entirety.

### BACKGROUND

### Technical Field

The present disclosure relates to a metal composite compound and a cathode active material with the metal composite compound as a precursor, in particular, to a metal composite compound with which a cathode active material with excellent rate characteristics during discharge can be obtained, and a cathode active material with the metal composite compound as a precursor.

### Description of the Related Art

In recent years, secondary batteries have been used in a wide range of fields, such as portable devices including mobile phones and portable personal computers, and vehicles that use or combine electricity as a power source, in order to reduce the environmental burden. Secondary batteries include, for example, lithium-ion secondary batteries using non-aqueous electrolytes. Secondary batteries using non-aqueous electrolytes, such as lithium-ion secondary batteries, are suitable for miniaturization and weight reduction, and have characteristics such as high utilization and high cycle characteristics.

To improve battery characteristics of lithium-ion secondary batteries, high battery capacity and high output characteristics are required. Thus, a hydroxide for a lithium composite oxide containing nickel as the main component is proposed, which is a cathode active material for a lithium-ion secondary battery, wherein the hydroxide exhibits, in an X-ray diffraction pattern obtained using CuKα radiation, a full width at half maximum of 0.1° to 0.60° for a peak near 19°, a full width at half maximum of 0.1° to 0.50° for a peak near 38°, and a full width at half maximum of 0.1° to 0.65° for a peak near 52° (Japanese Patent Laid-Open No. 10-310433).

Japanese Patent Laid-Open No. 10-310433 discloses that the discharge capacity of a lithium composite oxide depends on the full width at half maximum of a peak in a specific X-ray diffraction pattern of the raw material hydroxide, and that a high-capacity lithium composite oxide for a cathode active material can be obtained by using a hydroxide containing nickel as the main component having a relatively narrow full width at half maximum as a raw material.

On the other hand, in portable devices such as mobile phones and portable personal computers, electric vehicles using electricity as a power source, or hybrid vehicles combining electricity as a power source, a high discharge capacity is required for the non-aqueous electrolyte secondary battery serving as the power source. However, with respect to the precursor of the cathode active material disclosed in Japanese Patent Laid-Open No. 10-310433, there was room for improvement in enhancing the discharge capacity of non-aqueous electrolyte secondary batteries.

The present disclosure is related to providing a metal composite compound with which a cathode active material having an excellent discharge capacity can be obtained, and a cathode active material with the metal composite compound as a precursor.

### SUMMARY

In the metal composite compound, the relative standard deviation of a volume-based crystallite size distribution, calculated from a diffraction peak within the range 2θ=38±1° in a powder X-ray diffraction measurement using CuKα radiation, is adjusted to less than 0.70. Thus, in an embodiment of the metal composite compound, unevenness in the volume-based crystallite size distribution, calculated from a diffraction peak within the range 2θ=38±1° is suppressed. Furthermore, the metal composite compound of the present disclosure is a precursor of a cathode active material.

The summary of the configuration of the present disclosure is as follows.

[1]A metal composite compound, wherein a relative standard deviation of a volume-based crystallite size distribution, calculated from a diffraction peak within the range 2θ=38±1° in a powder X-ray diffraction measurement using CuKα radiation, is less than 0.70.

[2] The metal composite compound according to [1], wherein the metal composite compound has a tap density of 1.9 g/mL or less.

[3] The metal composite compound according to [1] or [2], wherein the metal composite compound is represented by the following formula:

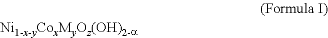

(wherein 0≤x≤0.3, 0≤y≤0.3, 0≤x+y≤0.3, 0≤z≤3, −0.5≤α≤<2, and α-z<2 are satisfied, and M is one or more additive elements selected from the group consisting of Mn, Fe, Cu, Ti, Mg, Al, Zn, Sn, Zr, Nb, Ga, W, Mo, B, and Si).

[4] The metal composite compound according to any one of [1] to [3], wherein the metal composite compound has a particle size at a cumulative volume percentage of 50% (D50) of 7.0 μm or more and 20.0 μm or less.

[5] The metal composite compound according to any one of [1] to [4], wherein a mode of the crystallite sizes in the crystallite size distribution is 30 Å or more and 200 Å or less.

[6] The metal composite compound according to any one of [1] to [5], wherein the relative standard deviation is 0.30 or more.

[7]A cathode active material for a non-aqueous electrolyte secondary battery, wherein the cathode active material is formed by calcining the metal composite compound according to any one of [1] to [6] with a lithium compound.

According to an embodiment of the metal composite compound of the present disclosure, the relative standard deviation of a volume-based crystallite size distribution, calculated from a diffraction peak within the range 2θ=38±1° in a powder X-ray diffraction measurement using CuKα radiation, is adjusted to less than 0.70, and thus a cathode active material having an excellent discharge capacity can be obtained.

According to an embodiment of the metal composite compound of the present disclosure, when the metal composite compound has a tap density of 1.9 g/mL or less, a cathode active material having an excellent discharge capacity can be more effectively obtained.

According to an embodiment of the metal composite compound of the present disclosure, when the metal composite compound has a particle size at a cumulative volume percentage of 50% (D50) of 7.0 μm or more and 20.0 μm or less, the relative standard deviation of a volume-based crystallite size distribution, calculated from a diffraction peak within the range 2θ=38±1° can be easily adjusted to less than 0.70.

### DETAILED DESCRIPTION

In the following, the metal composite compound of the present disclosure will be described in detail.

The metal composite compound of the present disclosure is secondary particles formed by agglomeration of the primary particles. The shape of the particles of the metal composite compound of the present disclosure is not particularly limited, and may include various shapes, such as a substantially spherical or substantially ellipsoidal shape.

In the metal composite compound of the present disclosure, the relative standard deviation of a volume-based crystallite size distribution, calculated from a diffraction peak within the range 2θ=38±1° in a powder X-ray diffraction measurement using CuKα radiation, is adjusted to less than 0.70.

In the metal composite compound of the present disclosure, the relative standard deviation of a volume-based crystallite size distribution, calculated from a diffraction peak within the range 2θ=38±1° in a powder X-ray diffraction measurement using CuKα radiation, is adjusted to less than 0.70, and thus a cathode active material with the metal composite compound of the present disclosure as a precursor has an excellent discharge capacity.

The relative standard deviation of the crystallite size distribution of the metal composite compound of the present disclosure is obtained by the following method.

First, for the metal composite compound in powder form, a powder X-ray diffraction measurement is performed using CuKα as the radiation source with a diffraction angle 2θ measurement range of 10° or more and 90° or less to obtain diffraction peaks within the range 2θ=38±1°. Examples of the X-ray diffraction measurement device used for the powder X-ray diffraction measurement include Ultima IV made by Rigaku Corporation.

The obtained diffraction peak data is loaded into an analytical software, analyzed using the FP method, then the analyzed data is output as a log-normal distribution, whereby the relative standard deviation of a volume-based crystallite size distribution is obtained. As the above analytical software, for example, PDXL2, a consolidated powder X-ray analytical software made by Rigaku Corporation may be used.

A metal composite compound having a relative standard deviation of less than 0.70 as described above exhibits a narrow distribution width in crystallite sizes, that is, reduced variation in crystallite sizes. A cathode active material, obtained by calcining a mixture of a metal composite compound with reduced variation in crystallite sizes and a lithium compound, exhibits an excellent discharge capacity because lithium-ion reaction occurs uniformly throughout the cathode active material during discharge.

The above relative standard deviation is not particularly limited as long as it is less than 0.70, and the upper limit value of the relative standard deviation is preferably 0.69 or less, more preferably 0.67 or less, and particularly preferably 0.65 or less from the viewpoint of further enhancement of the discharge capacity of the cathode active material with the metal composite compound of the present disclosure as a precursor. On the other hand, the lower limit value of the above relative standard deviation, for example, is 0.30 or more.

The upper limit value and the lower limit value of the above relative standard deviation may be optionally combined. The above relative standard deviation is preferably 0.30 or more and 0.69 or less, more preferably 0.30 or more and 0.67 or less, and particularly preferably 0.30 or more and 0.65 or less.

The mode of the crystallite sizes in the crystallite size distribution may be determined by analyzing the crystallite size distribution obtained by the above method using the analytical software described above.

The mode of the crystallite sizes in the crystallite size distribution is not particularly limited, and the lower limit value is preferably 30 Å or more, and particularly preferably 40 Å or more in terms of smooth lithium-ion reaction in the cathode active material contributing to an enhanced discharge capacity. On the other hand, the upper limit value of the mode of the crystallite sizes in the crystallite size distribution is preferably 200 Å or less, more preferably 150 Å or less, and particularly preferably 130 Å or less in terms of crystallite expansion and contraction during charge-discharge contributing to reduced degradation of the cathode active material.

The lower limit value and the upper limit value of the above mode may be optionally combined. The above mode is preferably 30 Å or more and 200 Å or less, more preferably 40 Å or more and 150 Å or less, and particularly preferably 40 Å or more and 130 Å or less.

The tap density of the metal composite compound of the present disclosure is not particularly limited, and the upper limit value is preferably 1.9 g/mL or less, more preferably 1.8 g/mL or less, and particularly preferably 1.7 g/mL or less from the viewpoint of obtaining a cathode active material having an excellent discharge capacity. On the other hand, the lower limit value of the tap density is preferably 1.0 g/mL or more, and particularly preferably 1.2 g/mL or more from the viewpoint of an improved packing density of the cathode active material.

The upper limit value and the lower limit value of the above tap density may be optionally combined. The tap density is preferably 1.0 g/mL or more and 1.9 g/mL or less, more preferably 1.2 g/mL or more and 1.8 g/mL or less, and particularly preferably 1.2 g/mL or more and 1.7 g/mL or less in terms of achieving an excellent discharge capacity while enhancing the packing density of the cathode active material.

The particle size at a cumulative volume percentage of 50% (D50) (hereinafter sometimes simply referred to as “D50”) of the metal composite compound of the present disclosure is not particularly limited, and the lower limit value is preferably 7.0 μm or more, more preferably 8.0 μm or more, and particularly preferably 10.0 μm or more from the viewpoint of an improved packing density of the cathode active material in the cathode. On the other hand, the upper limit value of D50 of the metal composite compound of the present disclosure is preferably 20.0 μm or less, more preferably 19.0 μm or less, and particularly preferably 18.0 μm or less from the viewpoint of the improvement in the contact with the electrolyte. The above upper limit value and lower limit value may be optionally combined.

Among them, to facilitate the control of the relative standard deviation of a volume-based crystallite size distribution, calculated from a diffraction peak within the range 2θ=38+1°, to less than 0.70, D50 is preferably 7.0 μm or more and 20.0 μm or less, more preferably 8.0 μm or more and 19.0 μm or less, and particularly preferably 10.0 μm or more and 18.0 μm or less. D50 described above refers to a particle size measured by a particle size distribution measurement device using a laser diffraction scattering method.

For the composition of the metal composite compound of the present disclosure, a metal composite compound represented by the following composition formula (1), that is, a nickel-containing hydroxide or a nickel-containing oxide may be available.

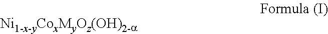

(wherein 0≤x≤0.3, 0≤y≤0.3, 0≤x+y≤0.3, 0≤z≤3, −0.5≤α≤2, and α-z<2 are satisfied, and M is one or more additive elements selected from the group consisting of Mn, Fe, Cu, Ti, Mg, Al, Zn, Sn, Zr, Nb, Ga, W, Mo, B, and Si).

The value of x is preferably 0.05≤x≤0.25, more preferably 0.07≤x≤0.20, and particularly preferably 0.10≤x≤0.15. The value of y is preferably 0.01≤y≤0.15, more preferably 0.02≤y≤0.10, and particularly preferably 0.03≤y≤0.07. The value of x+y is preferably 0.06≤x+y≤0.25, more preferably 0.10≤x+y≤0.22, and particularly preferably 0.12≤x+y≤0.20.

The metal composite compound of the present disclosure may be used as a precursor (hydroxide or oxide) of a cathode active material for a non-aqueous electrolyte secondary battery.

Next, a cathode active material for a non-aqueous electrolyte secondary battery with the metal composite compound of the present disclosure as a precursor (hereinafter may be simply referred to as a “cathode active material of the present disclosure”) will be described. The cathode active material of the present disclosure is formed by calcining the metal composite compound of the present disclosure, which serves as a precursor, for example, with a lithium compound in one embodiment. Since the metal composite compound of the present disclosure is calcined with a lithium compound, a non-aqueous electrolyte secondary battery having an excellent discharge capacity can be obtained.

The cathode active material of the present disclosure has a layered crystal structure, and from the viewpoint of obtaining a secondary battery with a high discharge capacity, a trigonal crystal structure, a hexagonal crystal structure, or a monoclinic crystal structure is preferred. The cathode active material of the present disclosure may be used as a cathode active material for a non-aqueous electrolyte secondary battery such as lithium-ion secondary batteries.

Next, the method for producing the metal composite compound of the present disclosure will be described. The method for producing the metal composite compound of the present disclosure includes a reaction step in which a metal-containing aqueous solution containing nickel, a complexing agent, and an alkaline aqueous solution are continuously supplied to a reaction tank to perform a crystallization reaction, thereby obtaining a metal composite compound, a slurry concentration step in which a slurry containing the metal composite compound is continuously withdrawn from the reaction tank and the slurry containing the metal composite compound is supplied to a sedimentation tank to concentrate the slurry, and a concentrated slurry circulation step in which the concentrated slurry is returned to the reaction tank.

### <Reaction Step for Obtaining Metal Composite Compound>

The reaction step for obtaining the metal composite compound refers to a crystallization step in which a metal-containing aqueous solution containing nickel, an alkaline aqueous solution which serves as a pH adjuster, and a complexing agent are added and mixed in a reaction tank to perform a co-precipitation reaction in the reaction solution, thereby obtaining a metal composite compound.

Specifically, according to the co-precipitation method, a metal-containing aqueous solution containing nickel, which includes a nickel salt (e.g., a sulfate) and optional components, i.e., a cobalt salt (e.g., a sulfate) and a salt (e.g., a sulfate) of an additive element M, an alkaline aqueous solution, and a complexing agent are added to a reaction tank, and the mixture is neutralized and crystallized in the reaction tank to prepare a metal composite compound, thereby obtaining a suspension in the form of slurry including the metal composite compound. Water, for example, is used as a solvent for the suspension.

The complexing agent is not particularly limited, provided that it can form a complex with nickel and optional components of cobalt and an additive element M in an aqueous solution. The examples include an ammonium ion donor (ammonium sulfate, ammonium chloride, ammonium carbonate and ammonium fluoride or the like), hydrazine, ethylenediaminetetraacetic acid, nitrilotriacetic acid, uracil diacetic acid, and glycine.

The alkaline aqueous solution is not particularly limited, provided that it is capable of adjusting the pH of the aqueous solution in the reaction tank during co-precipitation. The examples include an aqueous solution of alkaline metal hydroxide (such as sodium hydroxide and potassium hydroxide).

When the above metal-containing aqueous solution containing nickel, alkaline aqueous solution, and complexing agent are continuously supplied to the reaction tank, nickel and optional cobalt and additive elements M undergo a crystallization reaction to produce a metal composite compound. In the crystallization reaction, the temperature in the reaction tank is controlled, for example, within a range of 10° C. to 80° C., preferably 20° C. to 70° C., and the material in the reaction tank is appropriately stirred while adjusting the pH in the reaction tank within a range of, for example, pH 9 to pH 13, and preferably pH 10 to pH 12 based on a liquid temperature of 40° C. In an example of the reaction method, the metal composite compound formed is not discharged outside the system but circulated in the system to promote the growth of the metal composite compound particles.

In the method for producing the metal composite compound of the present disclosure, the concentration of the slurry containing the metal composite compound in the reaction tank is adjusted to 300 g/L or more. When the method includes the slurry concentration step and the concentrated slurry circulation step described later, the concentration of the slurry containing the metal composite compound in the reaction tank can be adjusted to 300 g/L or more.

Because the secondary particles forming the metal composite compound are agglomerates of crystallites, as the concentration of the secondary particles in the reaction tank increases, crystallite growth predominates over crystallite nucleation in the reaction system in the reaction tank. This suppresses the formation of fine crystallites and reduces variation in crystallite sizes, and it is believed that a metal composite compound with the relative standard deviation of less than 0.70 can be obtained. The concentration of the slurry containing the metal composite compound in the reaction tank may be measured by the following procedure.
(1) Withdraw a predetermined amount of slurry from the reaction tank.
(2) Weigh the watch glass and filter paper.
(3) Subject the collected slurry to suction filtration, place the resultant on the watch glass and dry the solid.
(4) Determine the weight of the solid content in the slurry from the reaction tank using an equation (solid content after drying+weight of watch glass+filter paper [g]−weight of watch glass+filter paper [g]).
(5) Calculate the concentration of the slurry using an equation (weight of solid content in slurry from reaction tank [g]+quantity of slurry collected [L])

### <Slurry Concentration Step>

The slurry concentration step refers to a step in which a slurry containing the metal composite compound continuously withdrawn from the reaction tank is supplied to the sedimentation tank and the metal composite compound undergoes sedimentation in the sedimentation tank, thereby concentrating the slurry containing the metal composite compound.

When the slurry containing the metal composite compound withdrawn from the reaction tank is supplied to the sedimentation tank, the slurry is separated into a concentrated slurry containing the metal composite compound in the lower layer and the supernatant solution in the upper layer of the sedimentation tank. The supernatant solution in the upper layer is discharged outside the system through the overflow pipe.

In the method for producing the metal composite compound of the present disclosure, the concentration of the concentrated slurry containing the metal composite compound (hereinafter sometimes referred to as the “concentrated slurry”) in the lower layer of the sedimentation tank is adjusted to 400 g/L or more. By controlling the holding time of the slurry containing the metal composite compound in the sedimentation tank, the concentration of the concentrated slurry can be adjusted to 400 g/L or more. When the concentration of the concentrated slurry is adjusted to 400 g/L or more, the concentration of the slurry containing the metal composite compound in the reaction tank can be easily adjusted to 300 g/L or more. The concentration of the concentrated slurry in the sedimentation tank can be calculated by quantity of solid circulated into reaction tank from sedimentation tank [g/minute]+quantity of liquid circulated into reaction tank from sedimentation tank [L/minute].

### <Concentrated Slurry Circulation Step>

The concentrated slurry circulation step refers to a step in which the concentrated slurry adjusted to a concentration of 400 g/L or more is returned to the reaction tank from the sedimentation tank.

By returning the concentrated slurry adjusted to a concentration of 400 g/L or more to the reaction tank from the sedimentation tank, the concentration of the slurry containing the metal composite compound in the reaction tank can be adjusted to 300 g/L or more. Examples of methods of returning the concentrated slurry to the reaction tank from the sedimentation tank include a method of arranging a liquid transfer pump on the circulation pipe connecting the sedimentation tank and the reaction tank.

### <Metal Composite Compound Recovery Step>

In the metal composite compound recovery step, the circulation of the slurry containing the metal composite compound from the reaction tank through the sedimentation tank back to the reaction tank is halted, and the slurry containing the metal composite compound is discharged from the reaction tank and the sedimentation tank by a pump or the like, thereby recovering the metal composite compound as a product.

Additionally, the method may, as necessary, further include a solid-liquid separation step, wherein the slurry containing the metal composite compound from the metal composite compound recovery step is filtered, and the metal composite compound is washed with an alkaline aqueous solution, and then the resultant is separated into a solid phase and a liquid phase to obtain the solid phase containing the metal composite compound. The method may, as necessary, further include a step to obtain a dried powder of the metal composite compound by drying the solid phase containing the metal composite compound. Before drying the solid phase, the solid phase may be washed with water or the like, as necessary.

Next, the method for producing the cathode active material of the present disclosure will be described. For example, in the method for producing the cathode active material of the present disclosure, first a lithium compound is added to the metal composite compound of the present disclosure to prepare a mixture of the metal composite compound and the lithium compound. The lithium compound is not particularly limited, provided that the compound includes lithium, and the examples include lithium carbonate and lithium hydroxide.

For the mixing ratio of the lithium compound and the metal composite compound, for example, the molar ratio of the lithium in the lithium compound to the total amount of the metals in the metal composite compound (the total amount of nickel and optional components of cobalt and additive elements M) is in a range of 1.00 or more and 1.10 or less.

Thereafter, the above mixture is calcined to produce the cathode active material. The calcination condition includes, for example, a calcination temperature of 600° C. or more and 1,000° C. or less, a temperature-increasing rate of 50° C./hour or more and 300° C./hour or less, and a calcination time of 5 hours or more and 20 or less. The calcination atmosphere is not particularly limited, and examples include air, oxygen, and the like. The calcination furnace used for calcination is not particularly limited, and the examples include a stationary box furnace, a roller hearth continuous furnace, and the like.

Next, a cathode using the cathode active material of the present disclosure will be described. A cathode has a cathode current collector and a cathode active material layer using the cathode active material of the present disclosure formed on the surface of the cathode current collector. The cathode active material layer includes the cathode active material of the present disclosure, a binder, and, as necessary, a conductive auxiliary. The conductive auxiliary is not particularly limited, provided that the conductive auxiliary can be used for non-aqueous electrolyte secondary batteries, and for example, a carbon material may be used. Examples of carbon materials include graphite powder, carbon black (e.g., acetylene black) and a fibrous carbon material. The binder is not particularly limited, and for example, a thermoplastic resin may be used. Examples of thermoplastic resins include polyvinylidene fluoride (PVdF), butadiene rubber (BR), polyvinyl alcohol (PVA), carboxymethylcellulose (CMC) and polytetrafluoroethylene (PTFE), and a combination thereof. The cathode current collector is not particularly limited, and the examples include a conductive metal material such as aluminum foil, nickel foil and stainless steel.

The method for producing a cathode includes, for example, preparing a cathode active material slurry by mixing a cathode active material, a conductive auxiliary and a binder. The above cathode active material slurry is filled into the cathode current collector by a known filling method, dried, and rolled to adhere to the cathode current collector by a press or the like.

A cathode using the cathode active material obtained as described above, an anode, an electrolyte solution containing predetermined electrolytes, and a separator are prepared by a known method, and a non-aqueous electrolyte secondary battery can be assembled.

Examples of anodes include an electrode formed from an anode active material layer using an anode active material supported by an anode current collector, and an electrode composed only of an anode active material. The anode active material is not particularly limited, provided that it is commonly used, and the examples include graphite such as natural graphite and artificial graphite, coke, carbon black, pyrolytic carbon, carbon fiber, and calcined organic polymer compound. The anode current collector is not particularly limited, and the examples include a metal material such as copper foil, nickel foil, and stainless steel.

Furthermore, a conductive auxiliary, a binder, or the like may be added to the anode active material layer, as necessary. Examples of conductive auxiliaries and binders are the similar as those used for the above cathode active material layer.

The method for producing an anode includes, for example, preparing an anode active material slurry by mixing an anode active material, optionally a conductive auxiliary, and a binder, with water. The above anode active material slurry is filled into the anode current collector by a known filling method, dried, and rolled to adhere to the anode current collector by a press or the like.

Examples of electrolytes in non-aqueous electrolytes include a lithium salt such as LiClO₄, LiPF₆, LiAsF₆, LiSbF₆, LiBF₄, LiCF₃SO₃, LiN(SO₂CF₃)₂, LiN(SO₂C₂F₅)₂, LiN(SO₂CF₃)(COCF₃), Li(C₄FgSO₃), LiC(SO₂CF₃)₃, Li₂B₁₀Cl₁₀, LiBOB (in which BOB refers to bis(oxalato)borate), LiFSI (in which FSI refers to bis(fluorosulfonyl)imide), lower aliphatic lithium carboxylate and LiAlCl₄. These may be used singly or two or more of them may be used in combination.

As a dispersion medium of electrolyte, for example, a carbonate such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy)ethane; an ether such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; an ester such as methyl formate, methyl acetate and γ-butyrolactone; a nitrile such as acetonitrile and butyronitrile; an amide such as N,N-dimethylformamide and N,N-dimethylacetamide; a carbamate such as 3-methyl-2-oxazolidone; a sulfur-containing compound such as sulfolane, dimethyl sulfoxide and 1,3-propanesultone, or an organic solvent into which fluoro groups are introduced (an organic solvent in which one or more hydrogen atoms are substituted with a fluorine atom) may be used. These may be used singly or two or more of them may be used in combination.

A solid electrolyte may also be used instead of the electrolyte solution containing electrolyte. Examples of solid electrolytes include an organic polyelectrolyte such as a polyethylene oxide polymer compound and a polymer compound including at least one polyorganosiloxane chain or polyoxyalkylene chain. What is called a gel-type polymer electrolyte, comprising a polymer compound retaining a non-aqueous electrolyte, may also be used. Examples also include an inorganic solid electrolyte containing a sulfide, such as Li₂S—SiS₂, Li₂S—GeS₂, Li₂S—P₂S₅, Li₂S—B₂S₃, Li₂S—SiS₂—Li₃PO₄, Li₂S—SiS₂—Li₂SO₄ and Li₂S—GeS₂—P₂S₅. These may be used singly or two or more of them may be used in combination.

The separator is not particularly limited, and a material in the form of a porous film, a nonwoven fabric, or a woven fabric may be used, which is formed from a material such as a polyolefin resin including polyethylene and polypropylene, a fluororesin or a nitrogen-containing aromatic polymer. These may be used singly or two or more of them may be used in combination.

### EXAMPLES

Next, Examples of the metal composite compound of the present disclosure will be described, but the present disclosure is not limited to these Examples, provided that it does not depart from the subject matter of the disclosure.

Production of metal composite compound of Examples and Comparative Examples

### Production of Metal Composite Compound of Example 1

A metal-containing aqueous solution containing nickel prepared by dissolving nickel sulfate, cobalt sulfate, and manganese sulfate at a predetermined molar ratio of nickel:cobalt:manganese and an aqueous sodium hydroxide solution were added dropwise to a reaction tank having a predetermined capacity. The mixture was continuously stirred by a stirrer while maintaining the temperature in the reaction tank at 60° C. and the pH in the reaction tank at 10.2 based on a liquid temperature of 40° C. The metal composite compound generated was caused to overflow through the overflow pipe of the reaction tank and supplied to a sedimentation tank with a predetermined capacity, and was subjected to sedimentation in the sedimentation tank for a predetermined time to concentrate the slurry containing the metal composite compound, and a concentrated slurry was obtained. The slurry concentration of the concentrated slurry settled in the lower layer of the sedimentation tank was 428 g/L. Next, the concentrated slurry was returned to the reaction tank from the sedimentation tank. The above step was continuously performed for a predetermined time, and the step was terminated when the concentration of the slurry containing the metal composite compound in the reaction tank reached 315 g/L, and the slurry containing the metal composite compound was discharged from the reaction tank and the sedimentation tank using a pump or the like, and the metal composite compound was recovered from the system. The metal composite compound recovered was subjected to water-washing, dehydration, and drying treatments to obtain the metal composite compound as a product.

### Production of Metal Composite Compound of Example 2

A metal-containing aqueous solution containing nickel prepared by dissolving nickel sulfate, cobalt sulfate, and manganese sulfate at a predetermined molar ratio of nickel:cobalt:manganese, an aqueous ammonium sulfate solution (complexing agent) and an aqueous sodium hydroxide solution were added dropwise to a reaction tank having a predetermined capacity. The mixture was continuously stirred by a stirrer while maintaining the temperature in the reaction tank at 60° C. and the pH in the reaction tank at 10.3 based on a liquid temperature of 40° C. The metal composite compound of Example 2 was obtained in the similar manner as in Example 1 except that the concentration of the slurry containing the metal composite compound in the reaction tank was 346 g/L and the slurry concentration of the concentrated slurry settled in the lower layer of the sedimentation tank was 473 g/L.

### Production of Metal Composite Compound of Example 3

A metal-containing aqueous solution containing nickel prepared by dissolving nickel sulfate, cobalt sulfate, and manganese sulfate at a predetermined molar ratio of nickel:cobalt:manganese, an aqueous ammonium sulfate solution (complexing agent) and an aqueous sodium hydroxide solution were added dropwise to a reaction tank having a predetermined capacity. The mixture was continuously stirred by a stirrer while maintaining the temperature in the reaction tank at 60° C. and the pH in the reaction tank at 10.7 based on a liquid temperature of 40° C. The metal composite compound of Example 3 was obtained in the similar manner as in Example 1 except that the concentration of the slurry containing the metal composite compound in the reaction tank was 308 g/L and the slurry concentration of the concentrated slurry settled in the lower layer of the sedimentation tank was 400 g/L.

### Production of Metal Composite Compound of Example 4

A metal-containing aqueous solution containing nickel prepared by dissolving nickel sulfate, cobalt sulfate, and manganese sulfate at a predetermined molar ratio of nickel:cobalt:manganese, an aqueous ammonium sulfate solution (complexing agent) and an aqueous sodium hydroxide solution were added dropwise to a reaction tank having a predetermined capacity. The mixture was continuously stirred by a stirrer while maintaining the temperature in the reaction tank at 60° C. and the pH in the reaction tank at 10.8 based on a liquid temperature of 40° C. The metal composite compound of Example 4 was obtained in the similar manner as in Example 1 except that the concentration of the slurry containing the metal composite compound in the reaction tank was 322 g/L and the slurry concentration of the concentrated slurry settled in the lower layer of the sedimentation tank was 420 g/L.

### Production of Metal Composite Compound of Comparative Example 1

A metal-containing aqueous solution containing nickel prepared by dissolving nickel sulfate, cobalt sulfate, and manganese sulfate at a predetermined molar ratio of nickel:cobalt:manganese, an aqueous ammonium sulfate solution (complexing agent) and an aqueous sodium hydroxide solution were added dropwise to a reaction tank having a predetermined capacity. The mixture was continuously stirred by a stirrer while maintaining the temperature in the reaction tank at 60° C. and the pH in the reaction tank at 11.2 based on a liquid temperature of 40° C. The metal composite compound of Comparative Example 1 was obtained in the similar manner as in Example 1 except that the concentration of the slurry containing the metal composite compound in the reaction tank was 263 g/L and the slurry concentration of the concentrated slurry settled in the lower layer of the sedimentation tank was 307 g/L.

### Production of Metal Composite Compound of Comparative Example 2

A metal-containing aqueous solution containing nickel prepared by dissolving nickel sulfate, cobalt sulfate, and manganese sulfate at a predetermined molar ratio of nickel:cobalt:manganese, an aqueous ammonium sulfate solution (complexing agent) and an aqueous sodium hydroxide solution were added dropwise to a reaction tank having a predetermined capacity. The mixture was continuously stirred by a stirrer while maintaining the temperature in the reaction tank at 60° C. and the pH in the reaction tank at 10.5 based on a liquid temperature of 40° C. The metal composite compound of Comparative Example 2 was obtained in the similar manner as in Example 1 except that the concentration of the slurry containing the metal composite compound in the reaction tank was 254 g/L and the slurry concentration of the concentrated slurry settled in the lower layer of the sedimentation tank was 484 g/L.

### Production of Metal Composite Compound of Comparative Example 3

A metal-containing aqueous solution containing nickel prepared by dissolving nickel sulfate, cobalt sulfate, and manganese sulfate at a predetermined molar ratio of nickel:cobalt:manganese, an aqueous ammonium sulfate solution (complexing agent) and an aqueous sodium hydroxide solution were added dropwise to a reaction tank having a predetermined capacity. The mixture was continuously stirred by a stirrer while maintaining the temperature in the reaction tank at 71° C. and the pH in the reaction tank at 11.2 based on a liquid temperature of 40° C. The metal composite compound generated was caused to overflow through the overflow pipe of the reaction tank and recovered. The metal composite compound recovered was subjected to water-washing, dehydration, and drying treatments to obtain the metal composite compound of Comparative Example 3 as a product. The concentration of the slurry containing the metal composite compound in the reaction tank was 116 g/L. As described above, in Comparative Example 3, the metal composite compound was not supplied to the sedimentation tank from the reaction tank, and accordingly, no concentrated slurry was prepared.

The evaluation items for physical properties of the metal composite compounds of Examples and Comparative Examples are as follows.

### (1) Composition Analysis of Metal Composite Compound

The composition analysis was performed by using an inductively coupled plasma optical emission spectrometer (Optima 8300 made by PerkinElmer Japan G. K.) after dissolving the obtained metal composite compound in hydrochloric acid.

(2) Relative Standard Deviation of Volume-Based Crystallite Size Distribution Calculated from Diffraction Peak within Range 2θ=38±1°

For the obtained metal composite compound, by performing a powder X-ray diffraction measurement (X-ray diffractometer: “Ultima IV” made by Rigaku Corporation) using CuKα as the radiation source with a diffraction angle 2θ measurement range of 10° or more and 90° or less, diffraction peaks within the range 2θ=38±1° were obtained. The obtained diffraction peak data was loaded into an analytical software (Consolidated Powder X-ray Analytical Software “PDXL2” made by Rigaku Corporation), analyzed using the FP method, then the analyzed data was output as a log-normal distribution, whereby the relative standard deviation of the volume-based crystallite size distribution calculated from diffraction peaks within the range 20=38±1° was obtained.

(3) Tap Density (g/mL)

The tap density was measured by a tap denser (KYT-4000 made by SEISHIN Enterprise Co., Ltd.) using the constant mass measurement method among the methods described in JIS R1628.

The evaluation results of physical properties of the metal composite compounds of Examples and Comparative Examples are shown in the following Table 1.

### Production of Cathode Active Material Using Metal Composite Compound of Examples and Comparative Examples as Precursor

A lithium hydroxide powder was added to and mixed with each of the metal composite compounds of Examples and Comparative Examples at a molar ratio of Li/(Ni+Co+Mn) of 1.05, to give a mixture of the metal composite compound and lithium hydroxide. The obtained mixture was subjected to calcination to obtain a lithium metal composite oxide for use as a cathode active material. The calcination conditions were an oxygen atmosphere, a temperature-increasing rate of 175° C./hour, a calcination temperature of 790° C., and a calcination time of 5 hours. In addition, a roller hearth kiln was used for calcination.

### Production of Cathode Using Cathode Active Material

A cathode was prepared using the cathode active material obtained as described above, and a battery for evaluation was assembled by using the cathode prepared. Specifically, the obtained cathode active material, a conductive auxiliary (acetylene black), and a binder (PVdF) were mixed at a weight ratio of 92:5:3, and the resulting mixture was applied to a cathode current collector (aluminum foil), dried and pressed to adhere to the cathode current collector, thereby forming a cathode.

A lithium secondary battery was prepared by using the cathode obtained as described above, an anode (metal lithium), an electrolyte solution containing electrolyte (LiPF₆) (a mixed solution of ethylene carbonate:dimethyl carbonate:ethyl methyl carbonate mixed at a volume ratio of 30:35:35), and a separator (made of polypropylene).

### Evaluation Items for Lithium Secondary Battery

### Capacity at 1 C Discharge Rate

The rate characteristics were evaluated as the capacity at a 1.0 C discharge rate, with a capacity at 1.0 C of 200 mAh/g, by performing charging and discharging under the conditions below. A capacity at a 1.0 C discharge rate of 185 mAh/g or more was deemed acceptable.
Test temperature: 25° C.
Maximum charge voltage: 4.3 V, charge current 1.0 CA, constant current constant voltage charging
Minimum discharge voltage: 2.5 V, discharge current 1.0 CA, constant current discharging

The evaluation results of the lithium secondary batteries of Examples and Comparative Examples are shown in the following Table 1.

TABLE 1

| | Composition | Relative | Tap | Capacity at |
|---|---|---|---|---|
| | (Molar ratio: | standard | density | 1 C discharge |
| | Ni/Co/Mn) | deviation | (g/mL) | rate (mAh/g) |
| Example 1 | 83/12/5 | 0.63 | 1.2 | 191.7 |
| Example 2 | 83/12/5 | 0.69 | 1.5 | 187.7 |
| Example 3 | 83/12/5 | 0.65 | 1.7 | 191.0 |
| Example 4 | 83/12/5 | 0.53 | 1.5 | 189.3 |
| Comparative | 83/12/5 | 0.77 | 2.1 | 183.1 |
| Example 1 | | | | |
| Comparative | 83/12/5 | 0.72 | 2.1 | 180.4 |
| Example 2 | | | | |
| Comparative | 83/12/5 | 0.73 | 2.0 | 178.1 |
| Example 3 | | | | |

Table 1 shows that the metal composite compounds of Examples 1 to 4 having a relative standard deviation of less than 0.70 which were produced by adjusting the concentration of the slurry containing the metal composite compound in the reaction tank at 300 g/L or more and the concentration of the concentrated slurry in the lower layer of the sedimentation tank at 400 g/L or more exhibit excellent discharge characteristics with a capacity at a 1.0 C discharge rate of 185 mAh/g or more. In particular, in Examples 1, 3, and 4 with a relative standard deviation of 0.65 or less, the capacity at a 1.0 C discharge rate was further improved.

Furthermore, in the metal composite compounds of Examples 1 to 4, the tap density was 1.2 g/mL to 1.7 g/mL.

By contrast, Table 1 shows that in the metal composite compound of Comparative Example 1 having a relative standard deviation of 0.77, where the concentration of the slurry containing the metal composite compound in the reaction tank was less than 300 g/L and the concentration of the concentrated slurry in the lower layer of the sedimentation tank was less than 400 g/L, the capacity at a 1.0 C discharge rate was less than 185 mAh/g, and excellent discharge characteristics were not achieved. Furthermore, in the metal composite compound of Comparative Example 2 having a relative standard deviation of 0.72, where the concentration of the slurry containing the metal composite compound in the reaction tank was less than 300 g/L while the concentration of the concentrated slurry in the lower layer of the sedimentation tank was 400 g/L or more, the capacity at a 1.0 C discharge rate was less than 185 mAh/g, and excellent discharge characteristics were not achieved. Moreover, in the metal composite compound of Comparative Example 3 having a relative standard deviation of 0.73, where the metal composite compound was not supplied to the sedimentation tank from the reaction tank and no concentrated slurry was prepared, the capacity at a 1.0 C discharge rate was less than 185 mAh/g, and excellent discharge characteristics were not achieved.

Furthermore, in the metal composite compounds of Comparative Examples 1 to 3, the tap density was 2.0 g/mL to 2.1 g/mL.

When a cathode active material prepared from the metal composite compound of the present disclosure as a precursor is used in a secondary battery, an excellent discharge capacity is achieved, thus enabling its use in a wide range of secondary battery applications, such as portable devices and vehicles.

What is claimed is:

1. A metal composite compound, wherein a relative standard deviation of a volume-based crystallite size distribution, calculated from a diffraction peak within a range 2θ=38±1° in a powder X-ray diffraction measurement using CuKα radiation, is less than 0.70.

2. The metal composite compound according to claim 1, wherein the metal composite compound has a tap density of 1.9 g/mL or less.

3. The metal composite compound according to claim 1, wherein the metal composite compound is represented by the following formula: 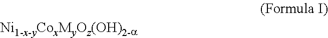
(wherein 0≤x≤0.3, 0≤y≤0.3, 0≤x+y≤0.3, 0≤z≤3, −0.5≤α≤2, and α-z<2 are satisfied, and M is one or more additive elements selected from the group consisting of Mn, Fe, Cu, Ti, Mg, Al, Zn, Sn, Zr, Nb, Ga, W, Mo, B, and Si).

4. The metal composite compound according to claim 1, wherein the metal composite compound has a particle size at a cumulative volume percentage of 50% (D50) of 7.0 μm or more and 20.0 μm or less.

5. The metal composite compound according to claim 1, wherein a mode of crystallite sizes in the crystallite size distribution is 30 Å or more and 200 Å or less.

6. The metal composite compound according to claim 1, wherein the relative standard deviation is 0.30 or more.

7. A cathode active material for a non-aqueous electrolyte secondary battery, wherein the cathode active material is formed by calcining the metal composite compound according to claim 1 with a lithium compound.
